(19) United States
(12) Patent Application Publication
(10) Pub. No.: US 2018/0124587 A1
(43) Pub. Date: May 3, 2018

(54) NETWORK DEVICE, COMPUTER NETWORK AND METHOD FOR CONTROLLING ENVIRONMENTS

(71) Applicants: Romano Rapallini, Genova (IT); Luca Gardini, Genova (IT)

(72) Inventors: Romano Rapallini, Genova (IT); Luca Gardini, Genova (IT)

(21) Appl. No.: 15/560,878

(22) PCT Filed: Mar. 21, 2016
(86) PCT No.: PCT/IB2016/051573

§ 371 Date: Sep. 22, 2017

(30) Foreign Application Priority Data
Mar. 23, 2015 (IT) GE2015A000037

(51) Int. Cl. H04W 4/38; H04W 4/02

(52) U.S. Cl. CPC H04W 4/38; H04Q 2209/60; H04Q 2209/40; H04W 4/02

(57) ABSTRACT

The invention relates to a network device (1), a network (2), and a method for controlling environments, wherein said device (1) comprises data acquisition and/or actuation means (11), first communication means (14) allowing said device (1) to communicate with at least one other device (1), second communication means (15) that can communicate with another device (1) and/or with a supervision device (3,22), control means (12) configured for controlling the device (1) in a manner such that it will operate in a first and/or in a second operating mode.

The present invention relates to a device for remote data acquisition, in particular for acquiring environmental and other data, as well as to a network made up of a plurality of said devices and a method for controlling environments.

As is known, the safety of people living on a particular territory is mainly dependent on the ability of the bodies in charge of controlling that territory (such as, for example, environmental control agencies, public safety authorities, and the like) to monitor and control the environment when a natural event (e.g. a flood, an earthquake, a seaquake, a landslide, or the like) or an artificial event (e.g. a big terrorist attack, a nuclear incident, a dam collapse, or the like) occurs which may endanger the safety of the people who live on the territory concerned by that event.

For the purpose of controlling the territory in a manner as capillary as possible, said bodies in charge of controlling the territory use so-called sensor networks that allow positioning a large number of sensors without also having to install costly infrastructures such as a point-to-point network, which would certainly be unfavourable because it would imply very high installation, management and maintenance costs.

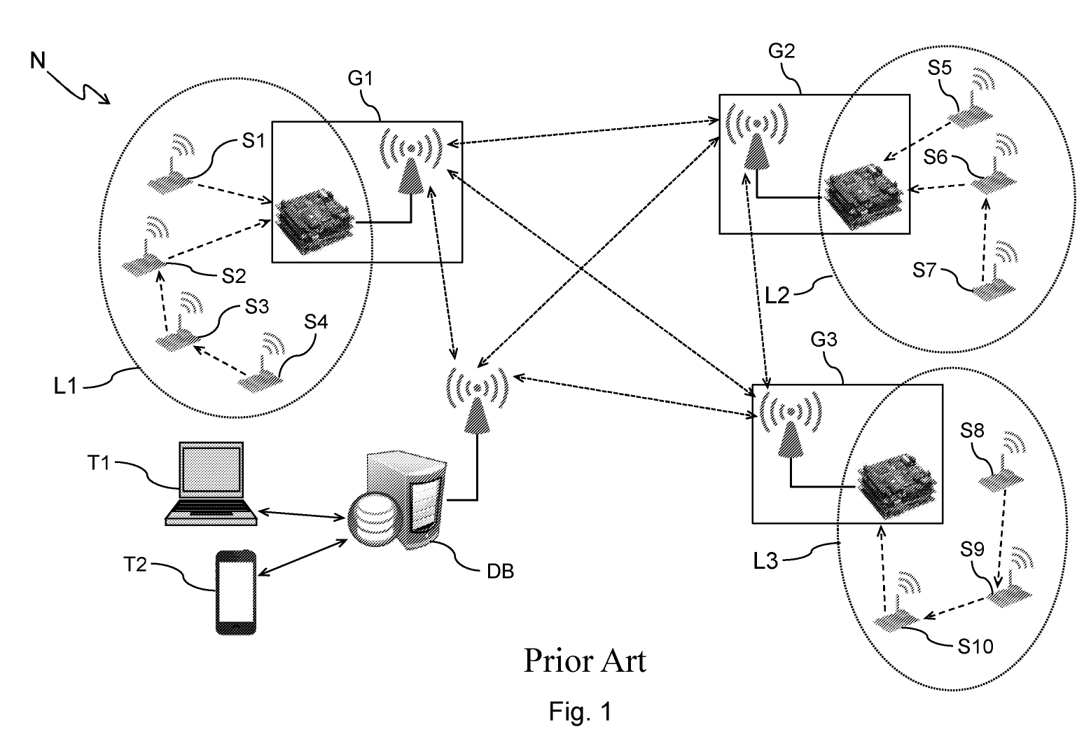

For example, a sensor network N like the one shown in FIG. 1 is generally made up of a plurality of acquisition nodes S1-S10, which are powered by batteries and which can acquire data detected by sensors (not shown in FIG. 1), such as, for example, thermometers, pluviometers, water level meters, seismometers, dosimeters or the like.

These acquisition nodes are usually arranged in groups L1-L3 over geographically different areas of the territory (e.g. different river beds), so that each acquisition node can communicate via radio with at least one other node or with a hub node G1-G3, which will take care of transmitting the data acquired by the acquisition nodes, whether directly or supported by another hub node, over a data transmission network (e.g. an urban WiFi network or a GPRS/UMTS/LTE cellular network) to an electronic computer DB containing a structured database for storing (in raw and/or aggregated form) the data acquired by the acquisition nodes. The data contained in the database can be read by a fixed supervision terminal T1 or by a mobile supervision terminal T2: in this manner, the territory over which the sensor have been installed can be monitored by means of a supervision terminal T1,T2.

These network, however, suffer from the limitation that the number and position of the acquisition nodes S1-S10 must be defined according to the number and position of the hub nodes, because each acquisition node has, due to intrinsic technical reasons, such as energetic efficiency and/or battery life, very low antenna transmission power (about one milliwatt), which requires, for the network to operate properly, positioning said acquisition node at a distance shorter than fifty meters from another acquisition node or hub node. Since hub nodes utilize, for transmitting the data to the electronic computer DB, WiFi or GPRS/UMTS/LTE networks that require higher antenna transmission power levels (hundreds of milliwatt), each hub node must be installed, in order to ensure an adequate level of service, on a site where adequate power supply is available. Preferably, power is supplied by an electric distribution network and at least one uninterruptible power supply, which allows said hub node to operate even when there is no mains power.

This requirement narrows very much the selection of sites for hub node installation, thus strongly affecting the structure of the sensor network. In fact, a sensor network should be designed and implemented on the basis of what such network will have to measure; instead, with the current types of sensor networks it is necessary to take into account the positions of the hub nodes, thus reducing the degree of territory control performance that could otherwise be offered by the sensor network.

Besides, the costs for installation, maintenance and management of the hub nodes lead engineers to design sensor networks with a limited number of such nodes, resulting in adverse consequences on network fault tolerance.

As a matter of fact, a reduced number of hub nodes, for the same number of acquisition nodes, will cause an increased average number of acquisition nodes that will not be able to transmit the acquired data when a hub node fails.

This situation, which is not at all rare in the event of a flood, an explosion or a seism causing prolonged service disruption (i.e. for a few days) of the electric mains, would expose the population on the territory to severe risks, e.g. because a watercourse overflow caused by a second flood may not be detected due to improper operation of the hub node that should receive data from the acquisition nodes detecting the levels of said watercourse.

What has been stated so far about sensor networks applied to open territories is also true, mutatis mutandis, for networks arranged in indoor or anyway circumscribed environments. Let us think, for example, of sensor networks for domotics, offices, facilities, etc., where alarm, fire, temperature sensors and the like are remotely connected to control means and possibly also to mobile network access devices for sending alarms to appointed persons. In these cases as well, the sensor network needs to be designed by taking into account the constrains imposed by the configuration and layout of the environments and/or of the devices with which the sensor can be associated, and so on.

This situation concerns, for example, the so-called domotics, i.e. that modern discipline which tackles the use of automation for controlling things.

The technical problem at the basis of the invention is to provide data acquisition and/or actuation devices, e.g. sensors and/or actuators of various kinds, having such structural and operating characteristics that allow the creation of networks capable of overcoming the limitations found in the prior art.

The idea that solves this problem is to provide data acquisition and/or actuation devices that comprise a plurality of communication interfaces adapted to constitute the nodes of a network, so as to allow each node to operate as a data acquisition and/or actuation node and also as a data distribution node, according to the circumstances.

This reduces the probability that a single node of a sensor network might not succeed in communicating the acquired data and/or receiving control data for actuator activation because of a failure suffered by another node in the network, since the nodes can receive/transmit data from/to other nodes or from/to a supervision terminal (i.e. they can operate as hub nodes), thus allowing the network to be configured in an operationally flexible manner and to adapt itself to the different conditions that may actually arise.

The invention also comprises a network and a method for controlling environments through the use of said network.

The features of the present invention are set out in the claims appended to this description. Such features, the effects deriving therefrom, as well as the advantages of the present invention will become more apparent from the following description of an embodiment thereof as shown in the annexed drawings, which are supplied by way of non-limiting example, wherein:

FIG. 1 shows a diagram of a sensor network according to the prior art;

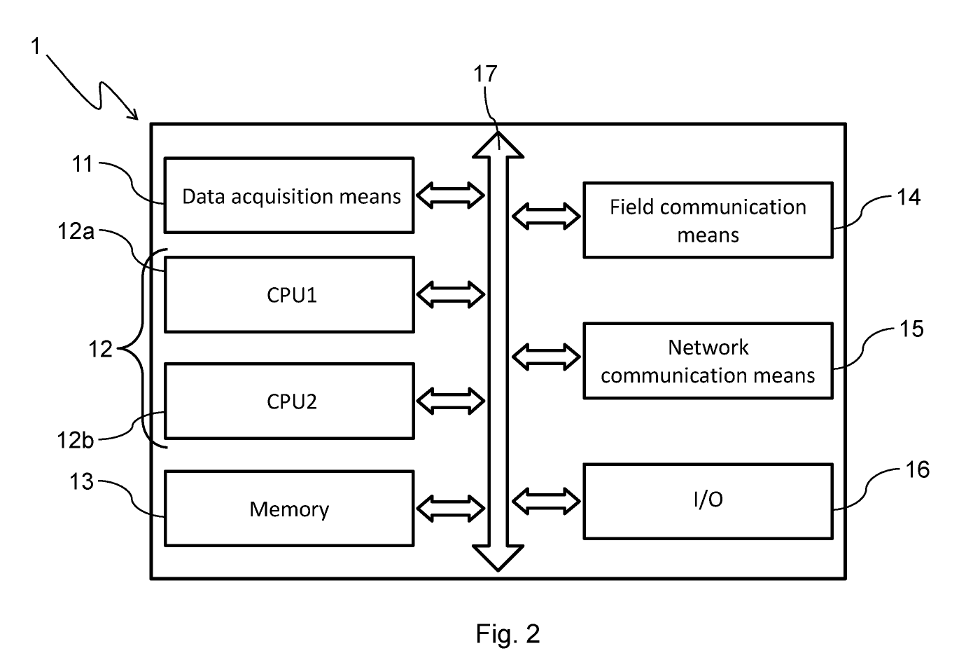

FIG. 2 shows a block diagram of a device for remote data acquisition according to the invention;

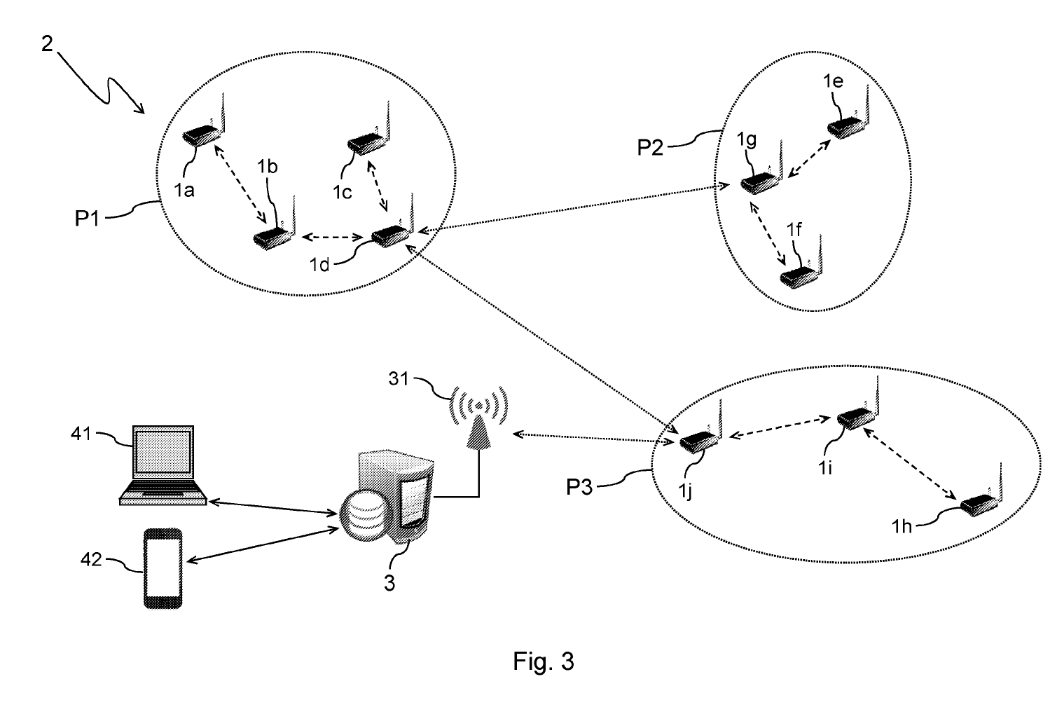

FIG. 3 shows a diagram of a sensor network wherein each node consists of a device like the one shown in FIG. 2;

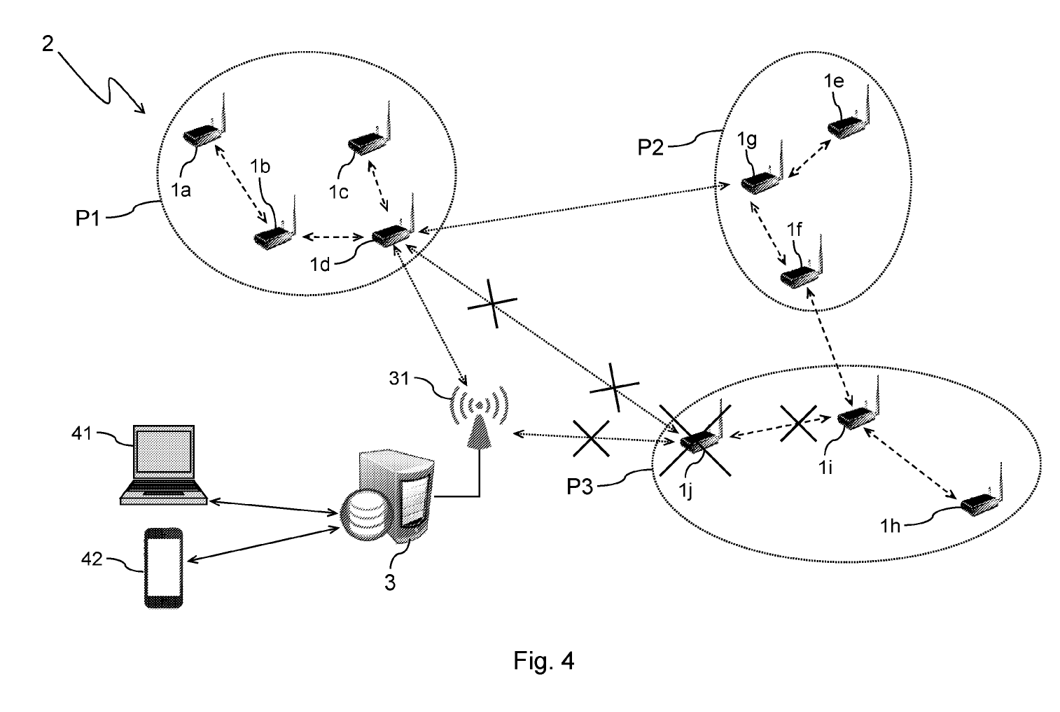

FIG. 4 shows the sensor network of FIG. 3 in a malfunctioning condition;

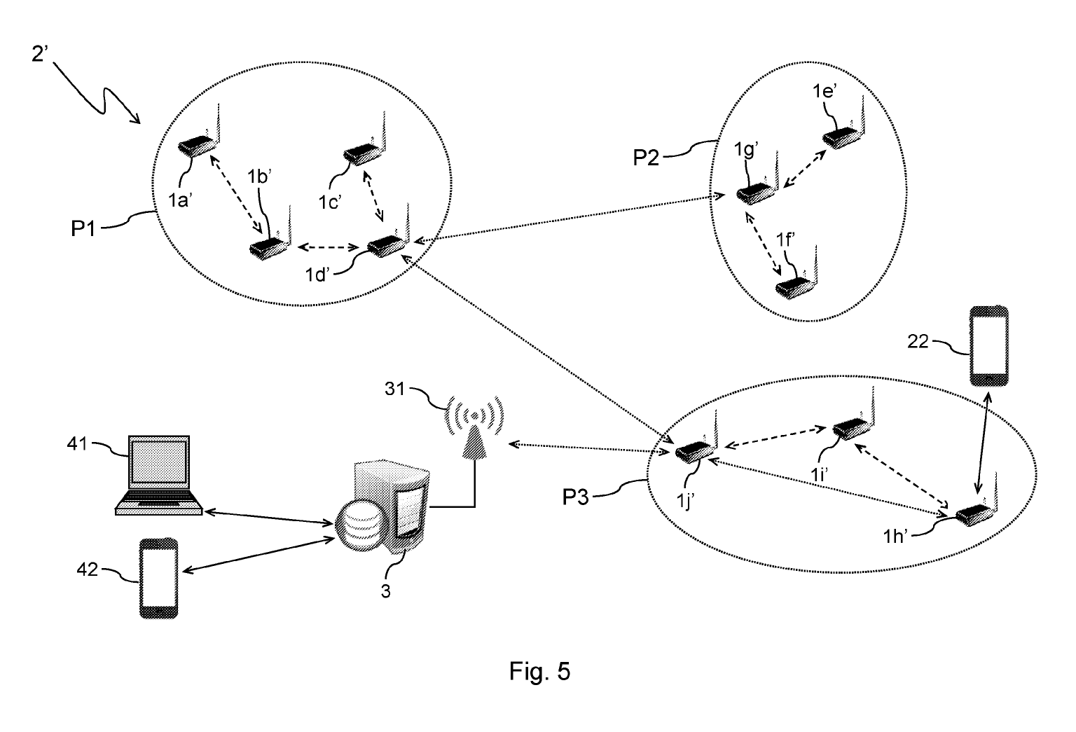

FIG. 5 shows a diagram of a sensor network wherein each node consists of a first variant of the device of FIG. 2;

FIG. 6 shows a possible diagram of a sensor network wherein each node consists of the main embodiment or the first variant of the device of FIG. 2.

Before proceeding any further, it is appropriate to point out that, in this description, any reference to “an embodiment” will indicate that a particular configuration, structure or feature is comprised in at least one embodiment of the invention. Therefore, the term “embodiment” and other similar terms, which may be present in different parts of this description, will not necessarily be all related to the same embodiment. Furthermore, any particular configuration, structure or feature may be combined in one or more embodiments described herein in any way deemed appropriate. The references below are therefore used only for simplicity's sake, and do not limit the protection scope or extension of the invention.

With reference to FIG. 2, an embodiment of the network device 1 (hereafter also referred to as acquisition and/or actuation node) according to the invention comprises the following components:
data acquisition and/or actuation means 11, which allow acquiring in digital format a signal coming from at least one sensor (e.g. a pressure, temperature, alarm, brightness, presence sensor or the like), wherein this signal can preferably be current-modulated (e.g. a current loop signal in accordance with the 4-20 mA standard) or modulated in accordance with any industrial automation standard (e.g. a field bus operating in accordance with the IEC 61158 international standard). As an alternative to or in combination with the above, said data acquisition and/or actuation means 11 also allow controlling one or more actuators (e.g. a servomotor, a relay, or the like) by generating a control signal preferably compliant with any commercial standard (e.g. DALI or the like);
control and processing means 12, e.g. one or more CPUs 12a,12b, governing the operation of the device 1, preferably in a programmable manner, through the execution of suitable instructions;
memory means 13, preferably a Flash memory or the like, in signal communication with the control and processing means 12, wherein said memory means 13 store at least the instructions that can be read by the control and processing means 12 when the device 1 is in an operating condition;
field communication means 14 (also referred to as first communication means), preferably an interface operating in accordance with the IEEE 802.15.4 standard and one or more of the ZigBee, WirelessHART, MiWi specifications or the like (i.e. an interface for a so-called “sensor network”), which allow said device 1 to communicate with at least one second device 1 (similar to the first one) either directly or indirectly, i.e. via a third device that may act as a repeater node, so as to make up for the low transmission power that needs to be used to ensure a sufficiently long operating time when the device 1 is battery powered;
network communication means 15 (also referred to as second communication means), preferably a network interface operating in accordance with a standard of the IEEE 802.11 (also known as WiFi) or 802.16 (also known as WiMax) families or an interface for a GSM and/or GPRS and/or UMTS and/or LTE or TETRA data network, which allow the device 1 to communicate with another device 1 and/or with a supervision device (the latter being further described below);
input/output (I/O) means 16, which may be used, for example, for connecting said device 1 to peripherals (e.g. data acquisition interfaces or the like) or to a programming terminal configured for writing instructions (which the processing and control means 12 will have to execute) into the memory means 13; such input/output means 14 may comprise, for example, a USB, Firewire, RS232, IEEE 1284 adapter or the like;
a communication bus 17 allowing information to be exchanged among the data acquisition means 11, the control and processing means 12, the memory means 13, the field communication means 14, the network communication means 15, and the input/output means 16.

As an alternative to the communication bus 17, the data acquisition means 11, the control and processing means 12, the memory means 13, the field communication means 14, the network communication means 15, and the input/output means 16 may be connected by means of a star architecture.

When the device is in an operating condition, the control and processing means 12 are configured for controlling the operation of the data acquisition means 11, the field communication means 14 and the network communication means 15 in a manner such that the device 1 will operate in at least one of the following modes:
a first operating mode (also referred to as data and/or instruction acquisition mode), wherein at least the data acquired through the data acquisition means 11 and/or received through the field communication means 14 and not exclusively directed towards the actuation means 11 of said device 1,1′ will be transmitted through said field communication means 14;
a second operating mode (also referred to as data distribution mode), wherein at least the data acquired through the data acquisition means 11 and/or received through the field communication means 14 and not exclusively directed towards the actuation means 11 of said device 1,1′ will be transmitted through the network communication means 15;

When the device 1 is operating in the first operating mode, it operates in a manner wholly similar to that of a normal sensor network, since it transmits the data acquired by the sensors through the data acquisition means 11 to another device 1 of the network 2 (another node of the sensor network, see dashed lines in FIG. 3) through the field communication interface 14, which operates at a low power level; furthermore, the device 1 can also, in this operating mode, take care of relaying (as aforementioned) the data received from a second device 1 to a third device 1 and receiving from other devices and/or from the supervision device instructions that will allow activating the actuation means 11 in such a way that they will operate the actuators as desired by an operator or according to control functions contained in said instructions or set beforehand in said device 1 or in other devices 1 of the same network, thereby ensuring proper operation of the sensor network.

It must be pointed out that, when the device 1 is operating in the data and/or instruction acquisition mode, it may even be made to work only as a repeater between two or more nodes, without acquiring any data and/or driving any actuators through the data and/or actuation means 11. This will improve the fault tolerance of the sensor network, thus advantageously increasing the probability that each node in the network will be able to transmit the data that it has acquired (through the data acquisition means 11) and/or to receive instructions even in the presence of one or more faulty nodes in the sensor network.

When the device 1 is operating in the second operating mode, it can receive, through the field communication means 14, the data acquired either directly or indirectly (i.e. relayed) by the near nodes that are operating in the first operating mode, and relay them, through the network communication means 15, to other nodes also operating in the second operating mode or to the supervision device (see dotted lines in FIG. 3), wherein the latter may be an electronic computer comprising a database or a mobile terminal (e.g. a smartphone, a tablet, or the like). When it is operating in the second mode, the device 1 also receives, via the network communication means 15, instructions for actuation means 11 of the devices 1, and relays, through the field communication means 14 and/or the network communication means 15, those instructions which are not exclusively directed towards the actuation means 11 of said device.

In the preferred embodiment, the control and processing means 12 comprise a first CPU (or microcontroller) 12a, preferably of the Atmel AVR® XMEGA® type (e.g. the Atxmega256A3U model), and a second CPU (or microcontroller) 12b, preferably of the Econais® WiSmart® type (e.g. the EC19D model), wherein said second CPU 12b is configured for controlling the operation of the first CPU 12a and, should the latter operate incorrectly (e.g. enter a stall condition), for taking control of the device 1 in the place of the latter. In combination with or as an alternative to this feature, the first CPU 12a may also be configured for controlling the second CPU 12b and possibly replace the latter should the second CPU 12b operate incorrectly.

This will reduce the probability that the device 1 might not be able to transmit the data acquired by it or by other devices and/or to receive instructions because of an internal crash, thus improving the level of safety of the people on the territory controlled by the sensor network to which the device 1 belongs.

When the Atxmega256A3U and EC19D microcontrollers are used for implementing this device, the former may be advantageously used as a first CPU 12a and also as data acquisition and/or actuation means 11, in that it includes an appropriate onboard circuitry for sampling and acquiring an analog or digital signal from the outside and/or for generating an actuation signal, while the EC19D microcontroller may be advantageously used as a second CPU 12b and also as network communication means 15, in that it includes an onboard network interface compatible with the IEEE 802.11b/g/n standard, which only requires a connection to an antenna, preferably of the Antenova® Rufa® type (e.g. the A5839 model).

It must also be pointed out that the field communication means 14 and the network communication means 15 preferably communicate in distinct frequency bands. More in particular, the upper extreme of the frequency band in which the field communication means 14 communicate (i.e. the “lowest frequency” part of the spectrum) is preferably lower than 1 GHz, while the lower extreme of the frequency band in which the network communication means 15 communicate (i.e. the “highest frequency” part of the spectrum) is preferably higher than 1 GHz.

This will avoid any interference between the signals emitted and/or received by the two communication means 14 and 15, thereby maximizing the probability that the device 1 will successfully transmit the data to another device 1 and/or to a supervision device and/or receive instructions, thus advantageously improving the level of safety of the people on the territory controlled by the sensor network to which the device 1 belongs. Moreover, both CPUs 12a and 12b can advantageously be configured for operating in the so-called “watchdog restart” mode, so that each one of them can restart autonomously in the event of a crash, which may be caused, for example, by a hardware error, which may occur more frequently in the presence of particularly adverse environmental conditions (e.g. sudden changes in temperature, lightning, strong variations in magnetic field intensity, radiations, etc.).

Also with reference to FIG. 3, the following will describe a sensor network 2 comprising a plurality of network devices 1 (hereafter referred to as “nodes”) and a supervision device 3. It must be pointed out that each node may comprise, in addition to the network device 1, also one or more sensors (not shown in the annexed drawings) of various types (e.g. weather, seismic, radio safety sensors and the like).

This sensor network 2 is preferably used for environmental monitoring of a territory; therefore, the sensor employed shall be of the type capable of measuring ambient temperature, atmospheric pressure, solar irradiation level, vibration induced by an earthquake, stress level of a rocky material along a fault, radioactivity in the environment (e.g. caused by the presence of radon gas or another source), or the like. As an alternative, the sensor network 2 may also be located in civil environments such as houses, offices, warehouses, etc. For example, in the case of a domestic environment such as a flat, a palace, a garden or the like, the sensors may be able to detect the operating state of a household appliance (e.g. a refrigerator, a washing machine or a dishwasher), the power consumption of a particular environment (e.g. a kitchen, a bathroom or the like), the presence of people in a particular environment (e.g. floor-mounted pressure sensors and/or volumetric sensors), intrusion attempts (e.g. an infrared sensor or a pressure switch capable of detecting the breaking of a window and/or the opening of a door).

The man skilled in the art will nevertheless be able to use this network 2 also in other indoor or outdoor environments without departing from the teachings of the present invention.

The sensor network 2 of FIG. 3 comprises ten nodes 1a-1j positioned in three distinct geographical areas P1-P3 (e.g. three distinct watercourses or the like). In each area, at least one of the nodes comprised in said area operates in data distribution mode (the so-called hub node); in the case shown in FIG. 3, this is node 1d for the area P1, node 1g for the area P2, and node 1j for the area P3. The remaining nodes 1a-1c, 1 e-1f, 1h-1i operate in data and/or instruction acquisition mode (the so-called acquisition and/or actuation nodes). As aforementioned, each node of the network may be connected to a sensor and/or an actuator (not shown in the annexed drawings), although this is not strictly necessary. In fact, the acquisition and/or actuation nodes acting also as repeaters, i.e. the nodes 1b and 1i, might not be in signal communication with sensors and/or actuators, since they might be useful only to allow the hub nodes 1d and 1j to receive the data respectively acquired by the nodes 1a and 1h, which, due to installation requirements, might be too far to be able to establish a direct connection to the hub nodes 1d and 1j.

As aforesaid, each node 1a-1j may also be configured for, in addition to acquiring signals from a sensor, driving actuators according to instructions received from a supervision device or another node. This will make it possible to control elements such as hydraulic gates, visual signs (e.g. road or railway signals) from a remote location or to transmit short text messages (SMS) for alarms or other purposes to all mobile terminals in a certain area (e.g. via the cell broadcast system) or other data, which may advantageously contribute to safeguarding the territory during an event of any kind, thereby improving the safety of the people on the territory.

In the network 2, the hub node 1g communicates with the hub node 1d, which in turn communicates with the node 1j, which communicates with the supervision device. It should be noted that this type of communication between the hub nodes is wholly exemplificative, and that the node 1g might communicate directly with the node 1j or with the supervision device; the same is also true for the other hub nodes.

For managing these communication routes at best, the different nodes of the network may advantageously use the IP communication protocol, in particular IPv6, which can be advantageously used also in IEEE 802.15.4 networks (see RFC 6282 produced by the IETF 6LoWPAN group). The use of IPv6 simplifies the operation of the network 2 because it allows any electronic computer or device capable of connecting to an IPv6 network to acquire data and/or send instructions (whether directly or indirectly) from/to any node of the network 2. Note that IPv6 is a protocol that can be used both in private networks and in public networks such as, for example, the Internet. For this reason, the supervision device can advantageously be located anywhere in the world, thus ensuring an effective monitoring of the territory that will positively increase the level of safety of the people on said territory.

As aforementioned, the nodes 1 may be powered by batteries, preferably lithium-polymer ones, which ensure an adequately long operating time. It must be pointed out that only the hub nodes have their network communication means 15 turned on, and therefore only such nodes absorb a higher level of electric current. Because of this, the sensor network can be designed in a manner such that those nodes which in normal conditions operate as hub nodes are positioned close to more stable power sources (such as, for example, a public lamp post or the like) or are equipped with adequate power generator systems (e.g. microsolar, microaeolian, electromagnetic or thermoelectric energy harvesting systems or the like), so as to ensure an adequate level of service of the network 2.

The supervision device is preferably an electronic computer 3 comprising at least one mass storage unit; said supervision device 3 is in signal communication with a communication interface 31 (e.g. an interface compatible with the IEEE 802.11 or 802.16 family standard), which allows it to receive and decode the signals issued by the network communication means 15 of the apparatuses 1 making up the nodes 1a-1j. In fact, the electronic computer 3 is configured for receiving at least part of the data acquired by said nodes 1a-1j and for storing them into the mass storage unit. The data are entered into and read from the mass storage unit by the electronic computer 3 through a program that implements a database, preferably a documental one (NoSQL, such as, for example, MongoDB or the like). By using this type of database it is advantageously possible to constantly keep under control a large amount of data acquired by the electronic computer 3 without increasing too much the workload of the electronic computer 3 (this would not be possible if a relational database were used). Thus, the data acquired by the nodes 1a-1j on the territory can be checked even when there are thousands of nodes and/or when the data are acquired very often (e.g. when a sampling period of just a few seconds is used), leading to increased safety of the people on said territory.

Nevertheless, it will still be possible to use a database of another kind (e.g. a relational database) or another system (e.g. a file system) in order to store the data into the mass storage unit, without however departing from the teachings of the present invention. A network 2 allows, for example, knowing the level of a watercourse at different points (even tens of them) and the level of its affluents (which may also flow partially under cover), without having to install a wired data network that in the event of a power blackout might not work. This is attained by arranging the covered nodes in a manner that they can communicate with each other in sequence, and that one of them can communicate with at least one node outside the covering. In this way, a level of spatial granularity of the data can be achieved which would be hardly attainable through a network according to the prior art unless a large number of dedicated hub nodes were used, which should be positioned above ground to ensure a sufficient level of service.

The network 2 also comprises at least one data reading device, which may be a personal computer 41 or a mobile terminal 42, wherein said data reading device is configured for accessing the data stored in the mass memory of the electronic computer 3, so as to allow an operator to read and/or display the data acquired by the network 2 (e.g. by means of graphs) and/or send instructions to the devices 1 of the network in order to have them drive one or more actuators to ensure an effective monitoring and control of the territory whereon the network 2 has been installed. The operator can gain access to such data via a web interface and/or via push notifications that the computer 3 will send to the reading device when a certain condition occurs (e.g. when a watercourse is about to overflow) and/or the like.

Also with reference to FIG. 4, the following will describe the network 2 when it is in a malfunctioning condition, which in this specific case is due to a faulty hub node 1j temporarily preventing the nodes 1i and 1h from transmitting their data to the electronic computer 3 and/or from receiving instructions from said computer 3.

This situation can, in fact, be solved by the acquisition node 1i by transmitting to the node 1f any data acquired by the same node 1i and any data received from the acquisition and/or actuation node 1h. Thus, the node 1f can then transmit the data to the hub node 1g, which in turn will transmit them to the hub node 1d, which, since it will not be able to transmit the data to the faulty node 1j, will transmit them directly to the interface 31 of the electronic computer 3. The reverse path will be followed for transmitting instructions from the electronic computer 3 to one of the acquisition and/or actuation nodes 1i and 1h.

Note that the network 2 can solve this problem, thus allowing all working nodes to transmit their data and/or to receive instructions, without having to elect a new hub node; this is possible because the node 1i can communicate, via the field communication means 14, with the node 1f (even if this is located in another area). If this should not be possible, the node 1i will have to change its operating mode to become a hub node and to attempt to communicate with the network interface 31 of the electronic computer 3. Should this be impossible as well, another new hub node will have to be elected, which in this specific case may be the node 1f, which will communicate with the node 1i and the node 1g and/or with the network interface 31 via the second network communication means 15.

It must be pointed out that the election of the hub nodes is preferably made by using a distributed control algorithm, the instructions of which will be executed simultaneously by the processing and control means 12 of all the devices 1 in the network. This control algorithm ensures that most devices can directly or indirectly communicate with the supervision devices, so as to ensure proper monitoring and control of the territory;

moreover, said algorithm may also minimize/maximize one or more technical parameters of the network.

In particular, the control algorithm may minimize the power consumption per time unit (e.g. one hour) of every single node, e.g. by reducing the number of hub nodes or by changing the hub nodes over time, so as to reduce the risk that battery-powered nodes might stop working because of an excessively low voltage of their batteries.

As an alternative to or in combination with power consumption minimization, the control algorithm may also minimize the network nodes' response time, e.g. by minimizing the average number of nodes through which the data acquired by a given node will have to pass in order to arrive at the electronic computer 3. It is thus advantageously possible to increase the frequency at which the signals coming the sensors of each network node will be read, thereby preventing congestion of the network 2. This turns out to be particularly advantageous when it is necessary to monitor in real time a phenomenon with very fast time dynamics (e.g. a flood or the wave of a tsunami, if the nodes are located in the sea near the shore), thereby improving the level of safety of the people on a particular territory.

Of course, the example described so far may be subject to many variations.

A first variant is shown in FIG. 5; for brevity, the following description will only highlight those parts which make this and the next variants different from the above-described main embodiment; for the same reason, wherever possible the same reference numerals, with the addition of one or more apostrophes, will be used for indicating structurally or functionally equivalent elements.

This first variant comprises a network 2′ similar to the network 2 of the main embodiment, wherein said network 2′ comprises nodes 1a′-1j′, each one consisting of a device 1′ similar to the device 1, but configured for being able to operate in both operating modes, i.e. for being an acquisition node and a hub node at the same time.

Thus, the network 2′ can be so configured as to allow the presence of two or more supervision devices.

More in detail, the network 2′ comprises a supervision device 22, preferably a mobile one (e.g. a smartphone, a tablet, or the like), comprising a network interface capable of communicating with the network communication means 15 of any node of the network 2′ (e.g. by using the WiFi interface). When this supervision device 22 connects to a node of the network 2′, this node will start operating, if it was not already, as a hub node, so as to be able to receive the data acquired by at least some of the nodes of the network 2′ and/or to transmit instructions to at least some of said nodes.

To this end, the device 22 is configured for requesting the data it needs to receive, while the network nodes 1a′-1j′ are configured for transmitting to said device 22 only the requested data. This prevents an excessive increase in network traffic, thus preserving the correct operation of the network 2′ and advantageously avoiding a reduction in the level of safety of the people on the territory being monitored by the network 2′.

In the example shown in FIG. 5, the supervision device 22 connects to the node 1h′, which then becomes a hub node, preferably only for communications towards the device 22; to do so, the node 1h′ connects to the node 1j′, which is a hub node for communications towards the electronic computer 2, and through which all the data acquired by and/or the instructions directed towards the other network nodes (1a′-1f′ and 1i′) pass. In this manner, the mobile supervision device 22 will be able to receive at least part of the data acquired by the network 2′ and/or to send instructions to at least part of the network nodes, regardless of whether the electronic computer 3 is working or not. The level of network fault tolerance will thus be improved, allowing an operator on the territory to see the data acquired by the network 2′ even in the absence of a data connection to the electronic computer 3, resulting in a higher level of safety for the operator and the other people on the territory. Furthermore, this technical feature allows information (such as, for example, text and/or voice messages) to be exchanged between the mobile supervision device 22 and the electronic computer 3 and/or another mobile supervision device, thereby allowing the operators to communicate with one other in any situation without having to resort to dedicated radio links (e.g. e network based on the TETRA system) or other communication systems; this will increase the level of safety of said operators and of the other people on the territory.

As aforementioned, this variant is particularly advantageous when operators are moving on a territory during or immediately after a particular event (e.g. a flood or an earthquake) and must quickly decide (even in the absence of telephone connections) whether they can or cannot carry out special interventions for ensuring the safety of things and/or people (e.g. clearing a river bed or evacuating a building) without exposing themselves to excessive risks. In fact, this variant allows one to rapidly know if the level of a river is rising (or if it is raining above ground and how much) even in a covered bed (where normally there is no cellular network signal) or if a tsunami wave is coming in an area that has just suffered an earthquake (where it is very likely that cellular networks are down due to a power blackout).

With reference to FIG. 6, the following will describe a network 2″ similar to the network 2′ of the above-described embodiment, wherein said network 2″ comprises nodes 1a″-1j″, each one consisting of a device 1 or 1′ which, as already described for the main embodiment, comprises network communication means capable of communicating with one another also through access to base stations BS of a cellular network, preferably a UMTS (3G) and/or LTE (4G) cellular network, so that the hub nodes 1d″,1g″,1j″ can communicate with one another and/or with the supervision devices 3,22 through the Internet or another public network (see dashed-dotted lines in FIG. 6). This makes the network installation process simpler, allowing the network to be rapidly deployed on the territory (e.g. by positioning the devices 1,1′ on existing lamp posts and/or on electric distribution poles and/or near power and/or gas and/or water meters equipped with remote reading function), because such devices 1,1″ can exploit an existing network infrastructure, so that a network (with a sufficiently thick grid) can be created in a short time which can improve the safety of the people on said territory.

The present description has tackled some of the possible variants, but it will be apparent to the man skilled in the art that other embodiments may also be implemented, wherein some elements may be replaced with other technically equivalent elements.

The present invention is not therefore limited to the explanatory examples described herein, but may be subject to many modifications, improvements or replacements of equivalent parts and elements without departing from the basic inventive idea, as set out in the following claims.

1. A network device comprising:
a data acquisition and/or actuation means adapted to be put in signal communication with at least one sensor and/or one actuator;
a first communication means for communicating with at least one other device;
a control means configured for controlling the operation of said data acquisition and/or actuation means and of said first communication means in a manner such that the device will operate in a first operating mode, in which at least the data acquired through the data acquisition means and/or received through said first communication means and not exclusively directed towards the actuation means of said device will be transmitted through said first communication means; and
a second communication means for communicating with at least one other network device and/or at least one supervision device, and wherein the control means are also configured for controlling the operation of said second communication means in a manner such that the device will operate in a second operating mode, in which at least the data acquired through the data acquisition means and/or received through the first communication means and not exclusively directed towards the actuation means of said device will be transmitted through said second communication means.

2. The device according to claim 1, wherein the control means comprise a first processing and control unit and a second processing and control unit in signal communication with each other, wherein one of said control units is configured for controlling the operation of the other processing and control unit and for taking control of the device in the place of the latter.

3. The device according to claim 1, wherein the control means is also configured for controlling the operation of said second communication means in a manner such that, when the device is operating in the second operating mode, also the data received through the first and second communication means and not exclusively directed towards the actuation means of said device will be transmitted through said second communication means.

4. The device according to claim 1, wherein the control means is configured for being able to operate simultaneously in the first and second operating modes, so as to allow the presence of two or more supervision devices and possibly the exchange of information between them.

5. The device according to claim 4, wherein the control means is configured for controlling the operation of the second communication means in a manner such that the device will transmit the data acquired through the data acquisition means and/or received through said first and second communication means to at least two distinct supervision devices and/or will receive from said at least two supervision devices the data directed towards the actuation means of said device.

6. The device according to claim 1, wherein the first and the second communication means are of the radio type and communicate in distinct frequency bands.

7. The device according to claim 6, wherein the upper extreme of the frequency band in which the first communication means communicate is lower than 1 GHz, and wherein the lower extreme of the frequency band in which the second communication means communicate is higher than 1 GHz.

8. The device according to claim 1, wherein the second communication means comprises an interface for a data network of the GSM and/or GPRS and/or UMTS and/or LTE type.

9. An information technology network for data acquisition, comprising a plurality of devices according to claim 1, and further comprising
a plurality of nodes communicating with one another, wherein each node comprises at least one of said devices; and
at least one supervision device configured for receiving, through a network interface, the data acquired by said devices, and wherein said data are transmitted by at least one of the devices operating in the second operating mode.

10. The information technology network according to claim 9, wherein the control means of the device associated with a node executes instructions useful for determining if said device should operate in the first and/or in the second operating mode, depending on the operating state of the devices of the other nodes.

11. The Information technology network according to claim 10, wherein the control means of the device associated with a node execute instructions useful for determining if said device should operate in the first and/or in the second operating mode depending on the operating state of said devices, so as to minimize electric energy consumption.

12. The Information technology network according to claim 9, wherein the supervision device is an electronic computer that comprises mass storage means for storing the data acquired by the network devices.

13. A method for controlling one or more environments comprising the use of an information technology network according to claim 9, wherein said information technology network comprises a plurality of network devices that can communicate with one another, and wherein at least one of said devices is in signal communication with at least one sensor and/or one actuator.

14. The method according to claim 13, wherein said devices are arranged over a territory to be monitored, and wherein said at least one sensor and/or actuator is adapted to monitor an environmental parameter.

15. The method according to claim 14, wherein the environments are outdoor environments, and the sensor is configured for detecting one or more parameters including temperature, pressure, light, vibration, stress level of a rocky material, emissions of radioactive gases, or other atmospheric parameters.

16. The method according to claim 13, wherein the environments are indoor environments, and wherein said at least one sensor is configured for detecting one or more of the following parameters: operating state of a household appliance, energy consumption, presence of people in said environment, intrusion attempts.
